(19) United States
(12) Patent Application Publication
(10) Pub. No.: US 2018/0282058 A1
(43) Pub. Date: Oct. 4, 2018

(54) BAG HOLDER APPARATUS

(71) Applicant: SEAN RANA, BRAMPTON (CA)

(72) Inventor: SEAN RANA, BRAMPTON (CA)

(21) Appl. No.: 15/940,005

(22) Filed: Mar. 29, 2018

Related U.S. Application Data
(60) Provisional application No. 62/480,366, filed on Apr. 1, 2017.

(51) Int. Cl. B65F 1/14; B65F 1/06

(52) U.S. Cl. CPC B65F 1/1415; B65F 1/06

(57) ABSTRACT

The apparatus is for use with a refuse container, a refuse bag and a plurality of clips. The container is of the type having a mouth which presents vertically upwardly in use and a rim which defines the entry to the mouth. The bag is of the type having an end portion which defines a mouth of the bag. The apparatus comprises a frame and securement apparatus. The frame, in use, is disposed at an operative position relative to the container and is engaged by the clips to suspend the bag interiorly of the container such that the mouth of the bag is open, presents upwardly and is disposed adjacent the rim of the container. The securement apparatus, in use, holds the frame at the operative position.

### RELATED APPLICATIONS

This application claims priority to U.S. Provisional Patent Application Ser. No. 62/480,366, incorporated herein by reference in its entirety.

### FIELD OF THE INVENTION

The invention relates to the field of household refuse collection.

### BACKGROUND OF THE INVENTION

It is well known for households to use containers to receive refuse and for such households to use disposable bags to line such containers. It is also well known that, for sundry reasons, households often use disposable bags that are not appropriately sized [undersized] for the container, with the result that the bag cannot be suspended from the rim of the container in the conventional fashion.

### SUMMARY OF THE INVENTION

Forming one aspect of the invention is apparatus for use with a refuse container and a refuse bag, the container being of the type having a mouth which presents vertically upwardly in use and a rim which defines the entry to the mouth, the bag being of the type having an end portion which defines a mouth of the bag. This apparatus comprises a bag holder and securement apparatus. The bag holder, in use, is disposed at an operative position relative to the container and suspends the bag interiorly of the container such that the mouth of the bag is open, presents upwardly and is disposed adjacent the rim of the container. The securement apparatus, in use, holds the bag holder at the operative position.

According to another aspect, the bag holder can include: a frame about which the end portion is draped in use; and a clip adapted to grip around the frame and, in use, the bag.

According to another aspect, the bag holder can comprise a plurality of clips.

According to another aspect, the frame can have a plurality of portions, each portion including a pair of elongate members disposed in angular relation; and a clip can be provided for each of said plurality of portions, the clip being adapted to grip a substantial portion of the length of each of the members of said each portion.

According to another aspect, in each portion, the elongate members of the pair can be disposed in perpendicular relation to one another.

According to another aspect, the securement apparatus can be defined by a plurality of grips, each grip having a fixed end connected to the frame and a free end which, in use, is releasably coupled to the refuse container.

According to another aspect, the free end can be a hooked end which, in use, receives the rim in gripping relation.

According to another aspect, the frame can have a plurality of linear sections; and the fixed ends of the grips can be pivotally connected to the linear sections for movement around pivot axes defines by the linear sections.

According to another aspect, the frame can be bisected into two parts, hingedly connected to one another for relative movement about a hinge axis in the manner of the leaves of a book; and the linear sections can be orientated parallel to the hinge axis.

According to another aspect, the plurality of grips can be a pair of grips, the grips being relatively elongate in the direction of the linear section to resist pivotal movement of the bag holder in the container.

According to another aspect, when the parts are disposed in coplanar relation, the frame can be substantially rectangular.

According to another aspect, in use, the mouth of the bag can be disposed beneath the rim of the container.

Forming another aspect of the invention is apparatus for use with a refuse container, a refuse bag and a plurality of clips. The container is of the type having a mouth which presents vertically upwardly in use and a rim which defines the entry to the mouth. The bag being of the type having an end portion which defines a mouth of the bag.

This apparatus comprises a frame and securement apparatus. The frame, in use, is disposed at an operative position relative to the container and is engaged by the clips to suspend the bag interiorly of the container such that the mouth of the bag is open, presents upwardly and is disposed adjacent the rim of the container. The securement apparatus, in use, holds the frame at the operative position.

Advantages, features and characteristics of the invention will become apparent upon review of the following detailed description and the appended drawings, the latter being briefly described hereinafter.

### BRIEF DESCRIPTION OF THE DRAWINGS

FIG. 1 shows apparatus according to an exemplary embodiment of the invention;

FIG. 1A is an enlarged view of the structure of encircled area 1A of FIG. 1;

FIG. 2 shows the apparatus of FIG. 1 assembled for use;

FIG. 2A shows the apparatus of FIG. 1 in a folded position;

FIG. 3 shows a refuse container and refuse bag of the prior art with which the apparatus of FIG. 1 can be used;

FIG. 4 shows the apparatus of FIG. 1 in use with the structure of FIG. 3;

FIG. 4A shows the apparatus of FIG. 1 in use with the structure of FIG. 3

FIG. 5 shows a view, similar to FIG. 4, of an alternate embodiment of the structure of encircled area 5 of FIG. 1;

FIG. 6 shows a view of an alternate embodiment of the invention in use with a refuse container;

FIG. 7 is an exploded view of the structure of FIG. 6;

FIG. 8 is a view of encircled area 8 of FIG. 7;

FIG. 9 is a view of the structure of FIG. 8 from another vantage point;

FIG. 9A is a view of an alternative embodiment of the structure of FIG. 9A of FIG. 7;

FIG. 9B is an exploded view of the structure of FIG. 9A;

FIG. 10 is a view of a further alternate embodiment of the structure of encircled area 5 of FIG. 4;

FIG. 11 is a view of a further alternate embodiment of the structure of encircled area 5 of FIG. 4;

FIG. 12 is a view of an alternate embodiment of the structure of encircled area 12 of FIG. 1;

FIG. 13 is a view of the structure of FIG. 12 in use with a refuse container;

FIG. 14 is a view, similar to FIG. 5, of a yet further alternative embodiment; and

FIG. 15 is a view of an alternative embodiment of the structure of FIG. 1A.

### DETAILED DESCRIPTION

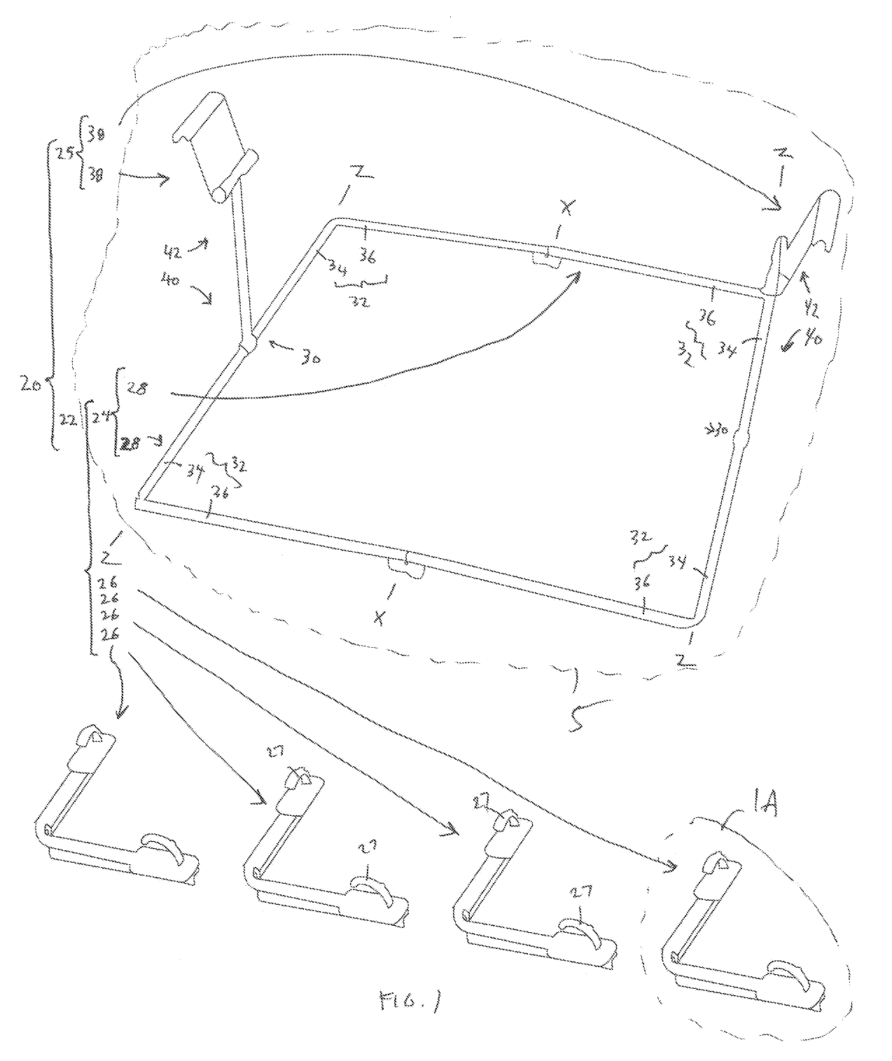

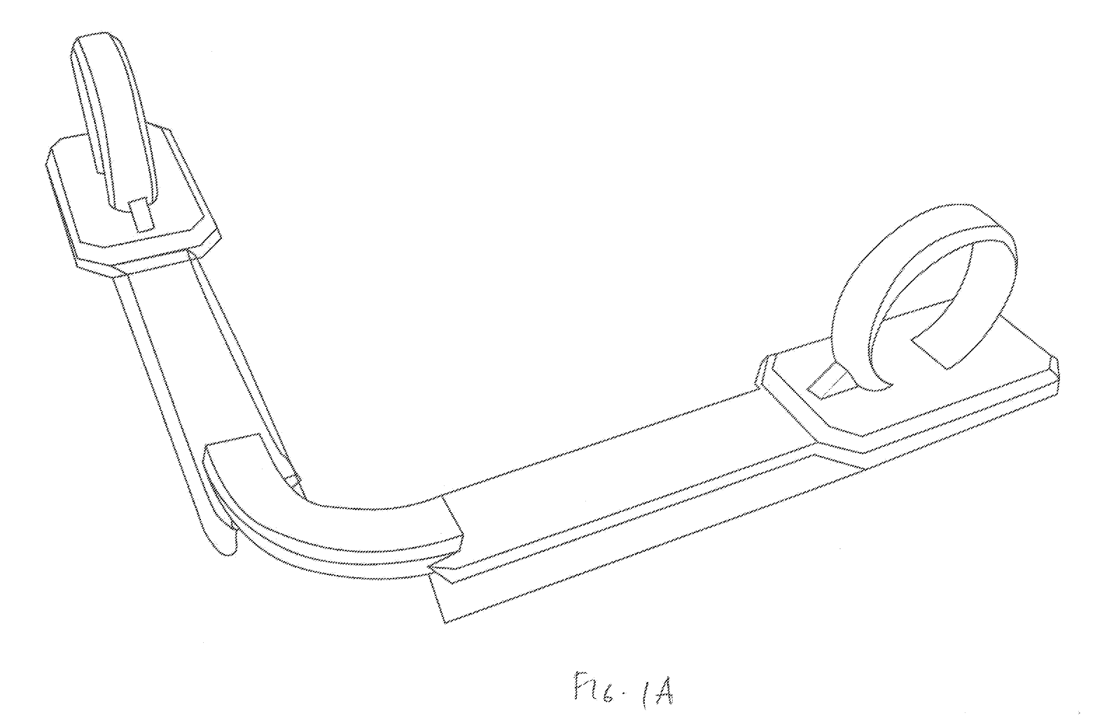

FIG. 1 shows apparatus 20 according to an exemplary embodiment of the invention, which apparatus will be seen to comprise a bag holder 22 and securement apparatus 25.

The bag holder 22 includes a frame 24 and a plurality of clips 26.

The frame 24 includes two substantially planar parts 28, hingedly connected to one another for movement about a hinge axis X-X. Each part 28 includes a linear section 30 and a pair of portions 32. Linear section 30 is orientated parallel to the hinge axis X-X. Each portion 32 includes a pair of elongate members 34,36 disposed in angular, more specifically, perpendicular relation, one 34 of the pair of elongate members forming a coaxial extension of the linear section 30 such that, when the parts are disposed in opposing relation, as shown in FIG. 1, the frame is substantially rectangular and planar.

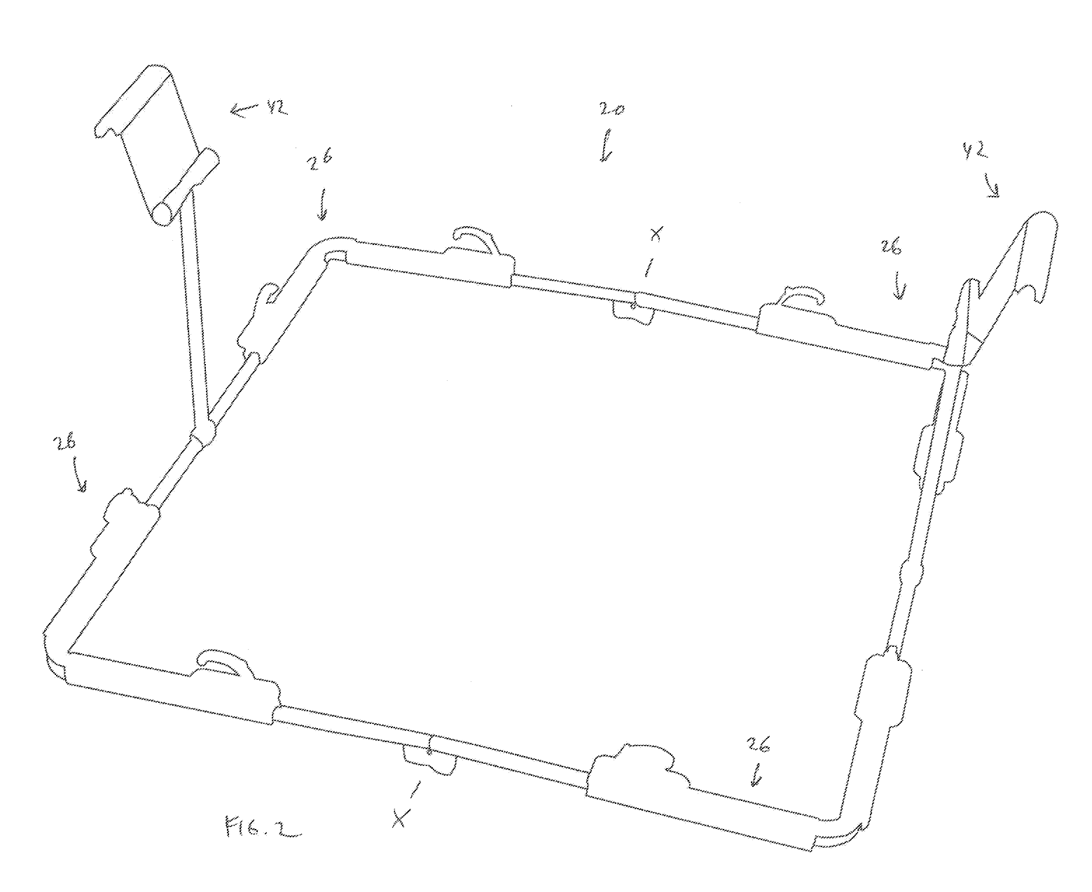

The clips 26 are provided one for each of the plurality of portions, each clip being adapted to grip a substantial portion of the length of each of the members 34,36 of the portion for which it is provided, as shown in FIG. 2. The clips 26 will be seen to include hooks 27 which facilitate removal from the frame.

The securement apparatus 25 is defined by a plurality of grips 38, specifically, a pair of grips, one being provided for each linear section 30, each grip having a fixed end 40 and a free end 42. The fixed end 40 is pivotally connected to the linear section 30 for which it is provided for movement around a pivot axis Z-Z defined by the linear section 30. The free end 42 is a hooked end, the hooked end being relatively elongate in the direction of the linear section 30.

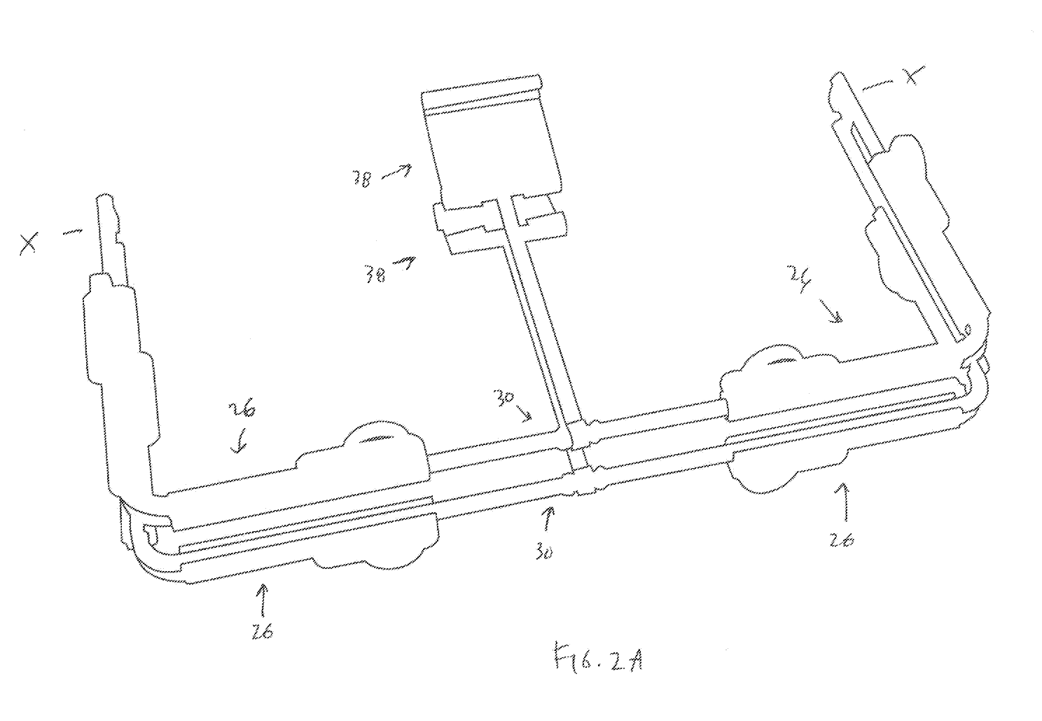

The apparatus 20 is used with a refuse container 44 and a refuse bag 46, the container being of the prior art type having a mouth 48 which presents vertically upwardly in use and a rim 50 which defines the entry to the mouth, the bag being of the prior art type having an end portion 52 which defines a mouth 54 of the bag, all as shown in FIG. 3.

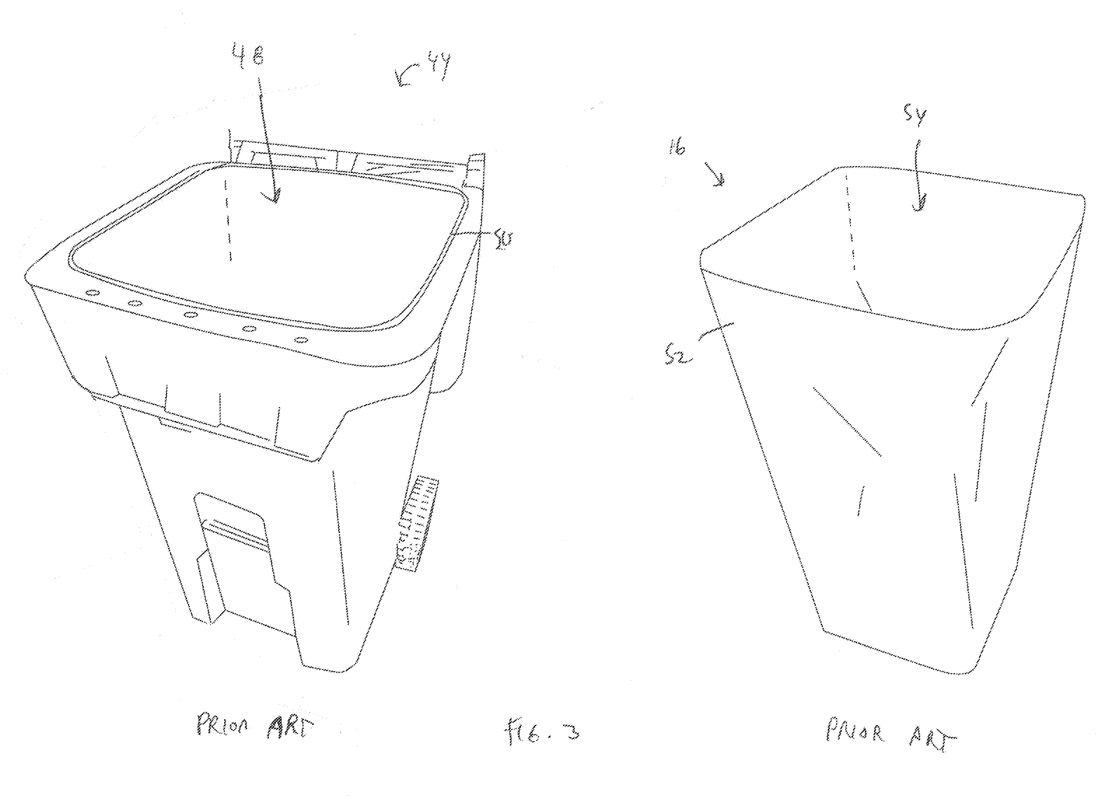

In use, as shown in FIG. 4:
the end portion 52 of the bag is draped around the frame 24;
each clip 26 is disposed in gripping relation to the members 34, 36 of the portion 32 for which it is provided and that portion of the bag disposed there between; and
each hooked end 42 receives the rim 50 in gripping relation, thereby to support the bag holder 20 in an operative position and configuration wherein the bag holder 20 suspends the bag 46 interiorly of the container such that the mouth of the bag is open, presents upwardly and is disposed beneath the rim of the container.

Whereas a specific embodiment is shown and described, it will be evident that variations are possible.

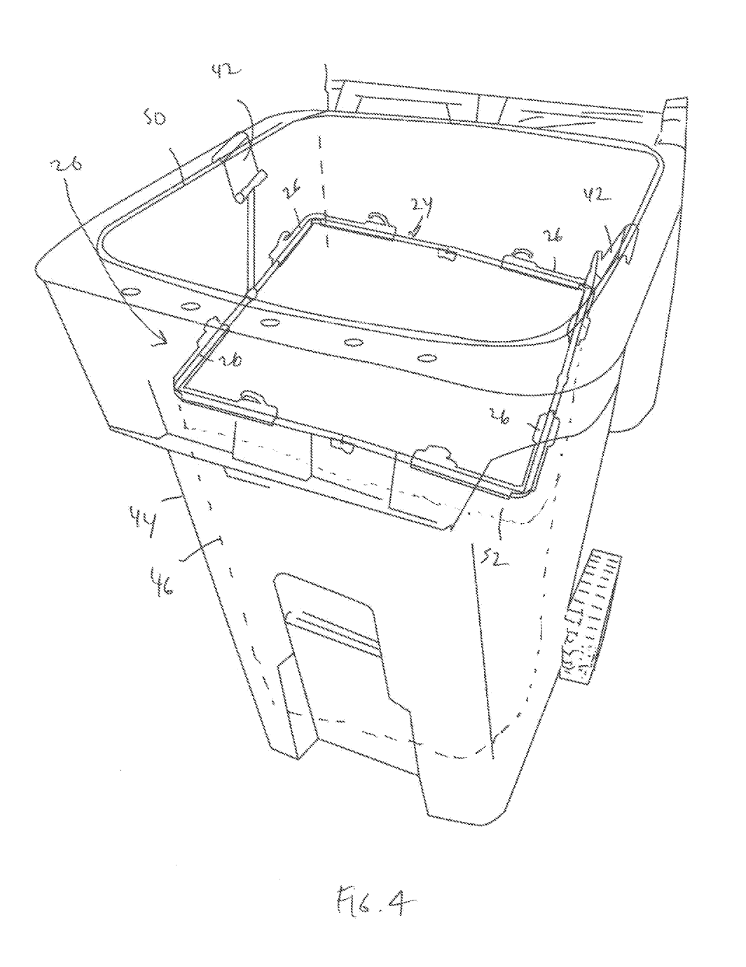

For example, whereas the illustrated frame is hinged and rectangular, this is not necessary; a solid frame 24A is shown in FIG. 5. Other shapes, such as circular frames, could also of course be used; this could be of particular use in the context of round refuse containers.

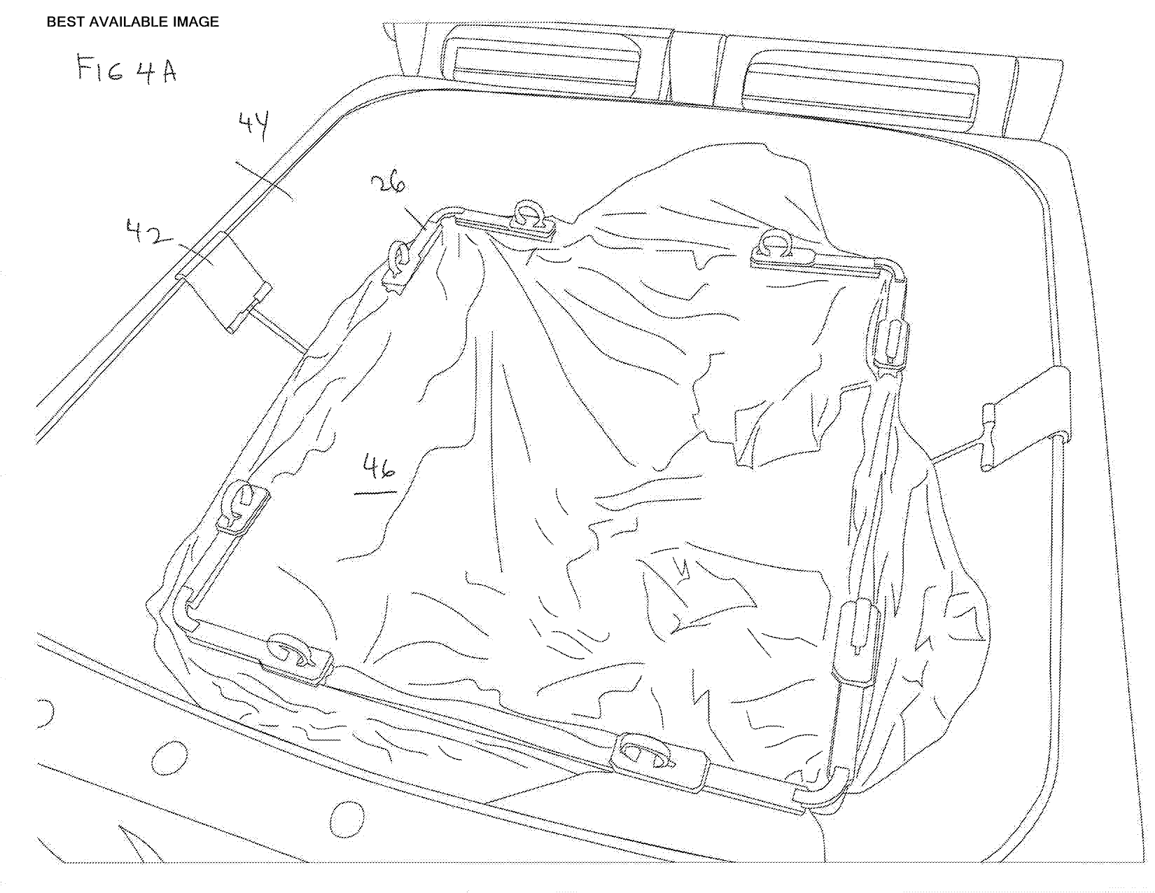

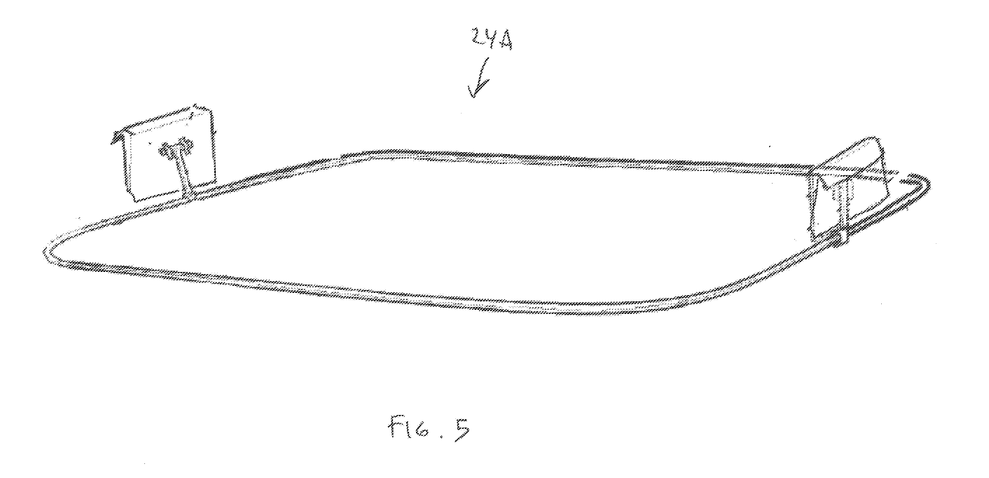

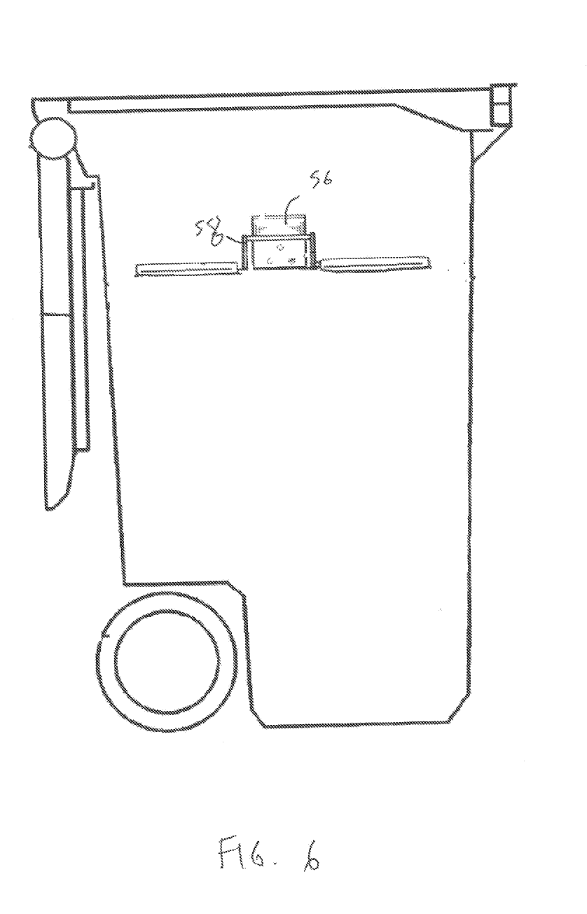

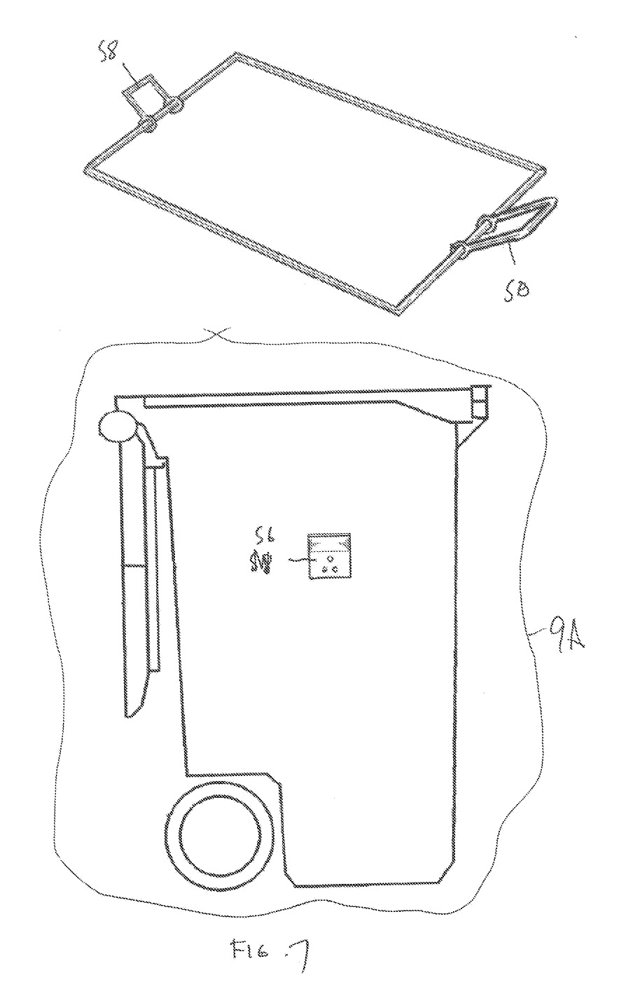

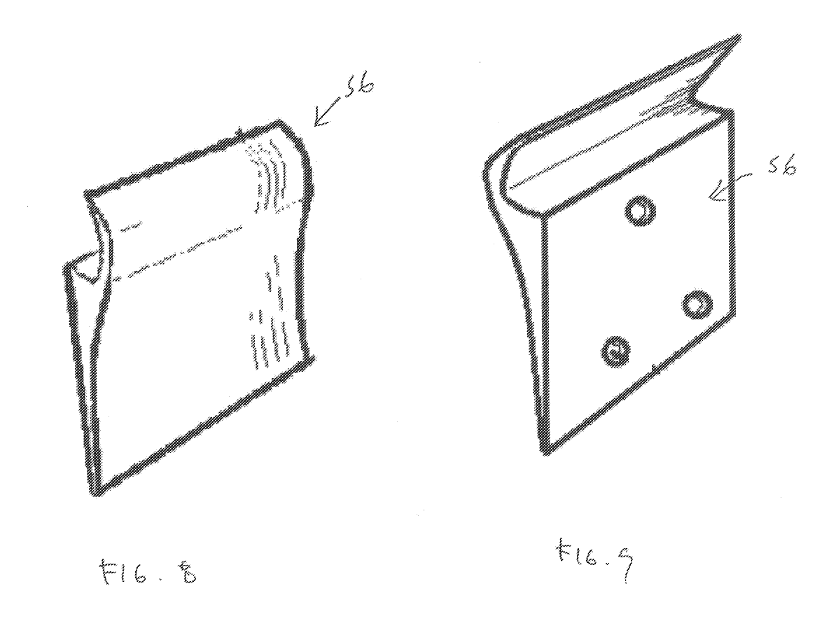

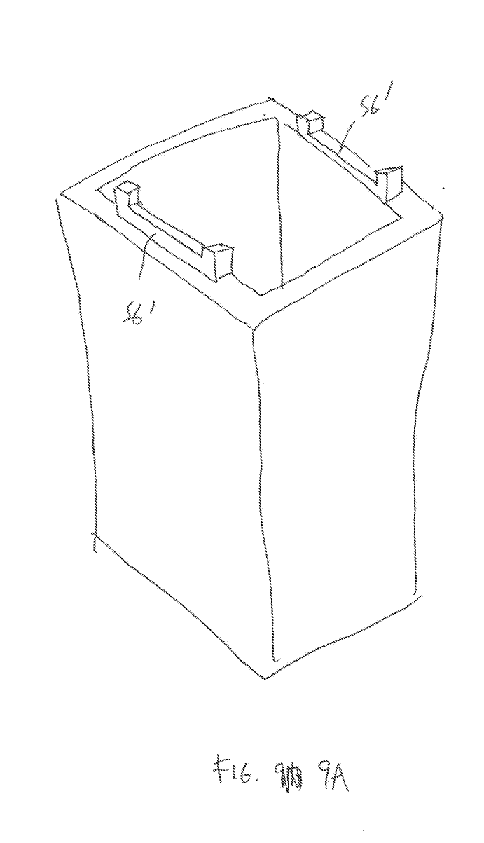

As well, whereas the illustrated securement apparatus includes hooks for engaging the rim of the refuse container, the apparatus could utilize other mechanisms for releasably engaging a refuse container. For example, FIGS. 6-9 show an embodiment wherein brackets 56 are mounted to the walls of the container and closed hooks 58 releasably engage the brackets in use. In the context of containers that terminate in rims with thick, planar, horizontal surfaces, brackets could also be mounted upon such surfaces, as indicated by FIGS. 9A, 9B, which show brackets 56′ so mounted; such brackets 56′, for example, could conveniently receive the structure of FIG. 2.

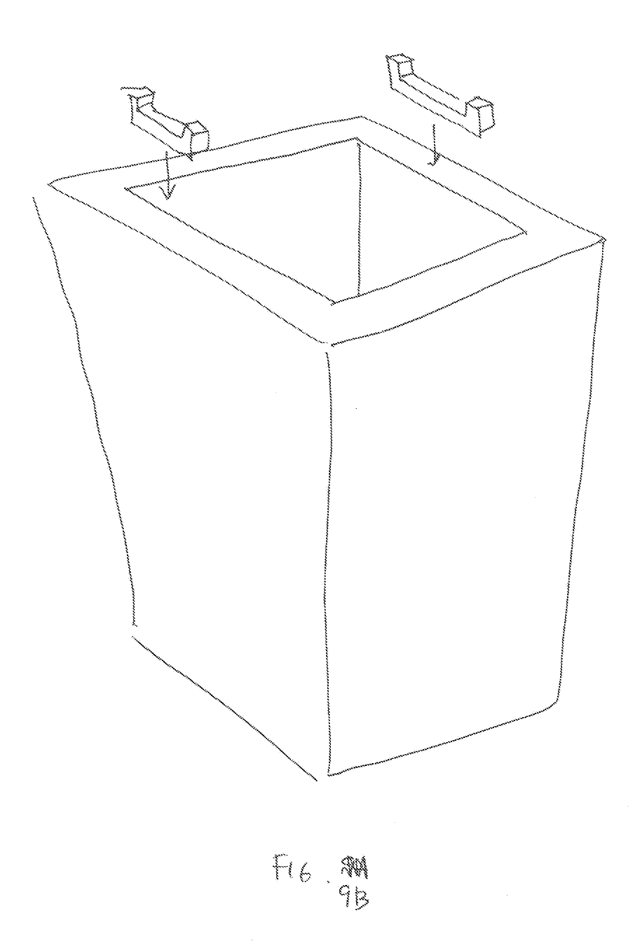

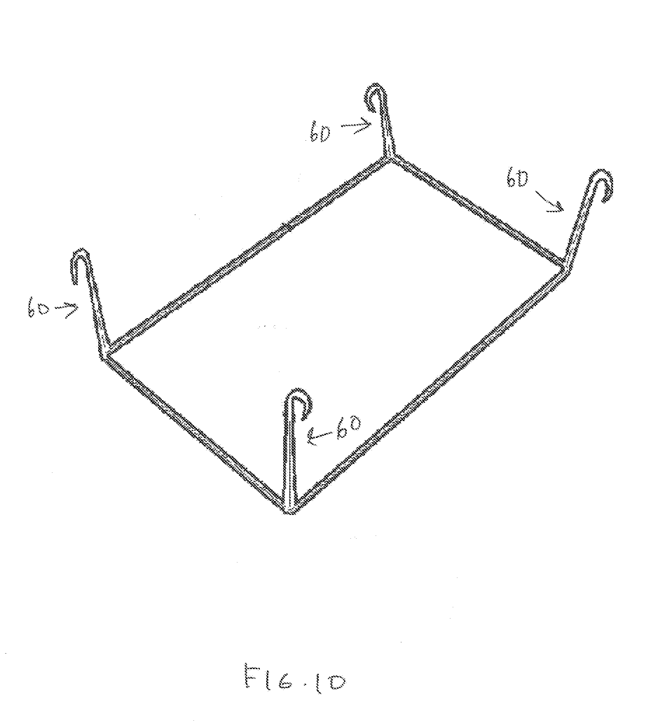

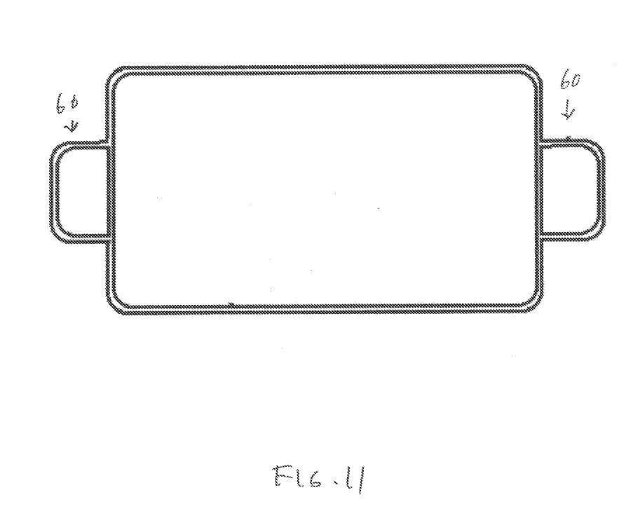

Further, whereas the grips in the exemplary embodiment are pivotally connected, this is not necessary; FIGS. 10 and 11 show embodiment having grips 60 rigidly mounted to the frame. Although structures showing two and four grips are shown, it will be evident that any number of grips could be utilized.

Further, whereas a specific refuse container and refuse bag are illustrated, it will be appreciated that the illustrated apparatus could be used with refuse containers and refuse bags of various sizes by virtue of, inter alia, the hinged connection between the parts and the pivotal connections of the grips.

Moreover, the apparatus could also be varied in size and shape, to accommodate even broader ranges of containers and bags.

As well, whereas the illustrated embodiment shows a refuse container with a hinged lid, it will be appreciated that a lid is not necessary, let alone a hinged lid.

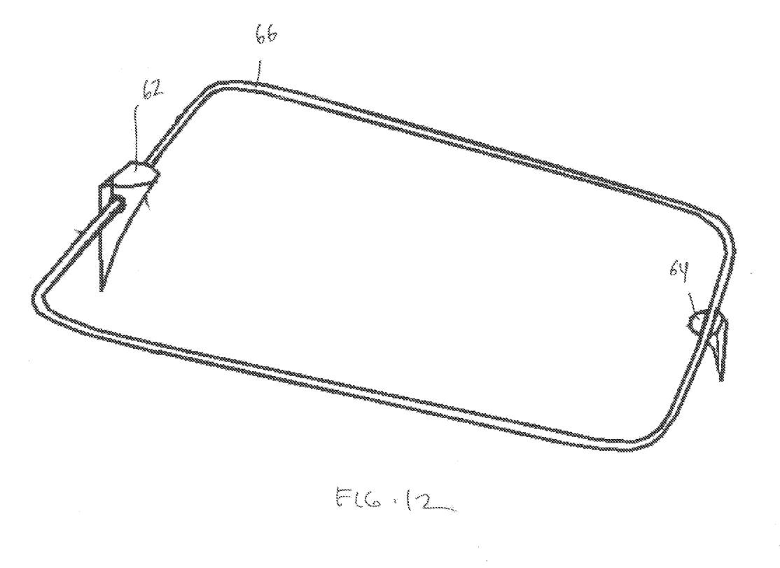

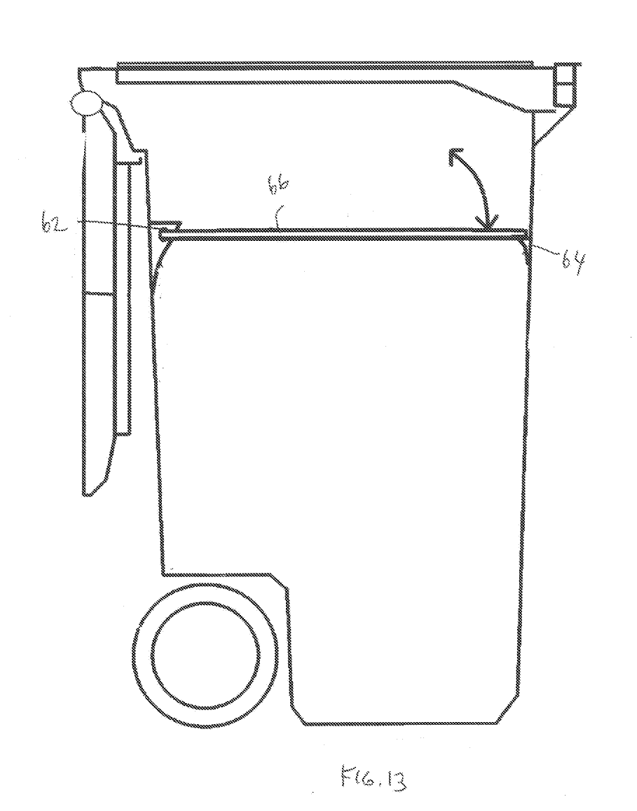

Additionally, whereas in the exemplary embodiment, the frame is fully releasable, this is not strictly necessary; FIG. 12 shows an embodiment of the frame and securement means which includes brackets 62, 64 intended for permanent affixation to the container and a frame 66 pivotally mounted to one of the brackets 62 and adapted for snap fit engagement with the other bracket 66, shown mounted for use in FIG. 13.

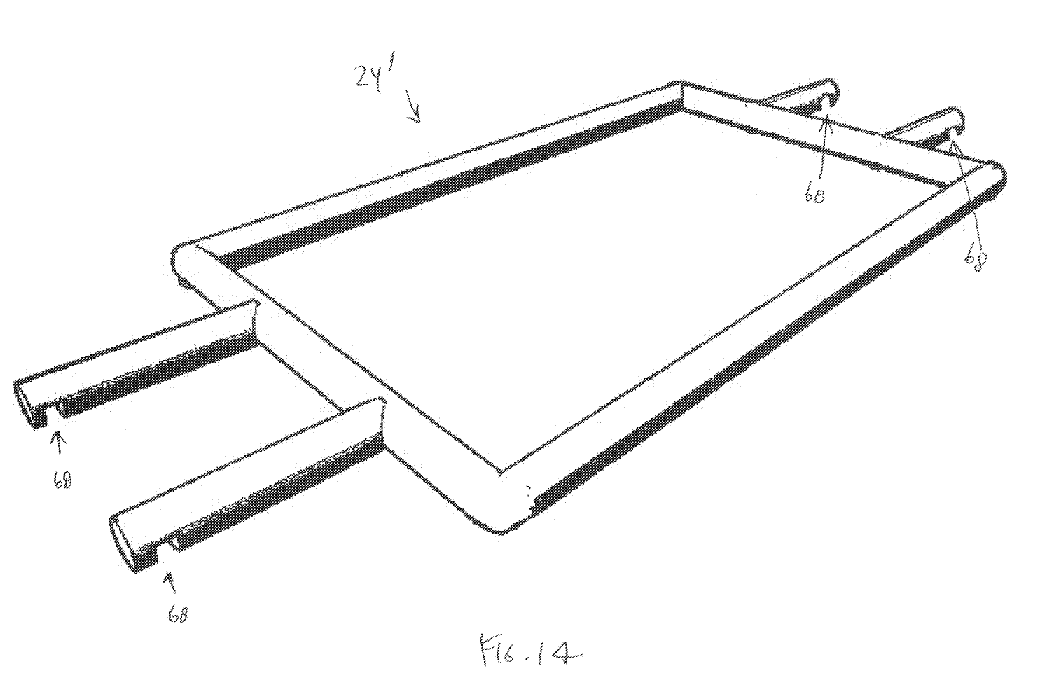

Yet further, whereas in the exemplary embodiment, the mouth is suspended beneath the rim of the container, this is not strictly necessary. For example, FIG. 14 shows a version of the frame which is substantially planar, having a plurality of slots 68 defined in the underside of projecting posts, which slots engage the rim of the refuse container in use (not shown).

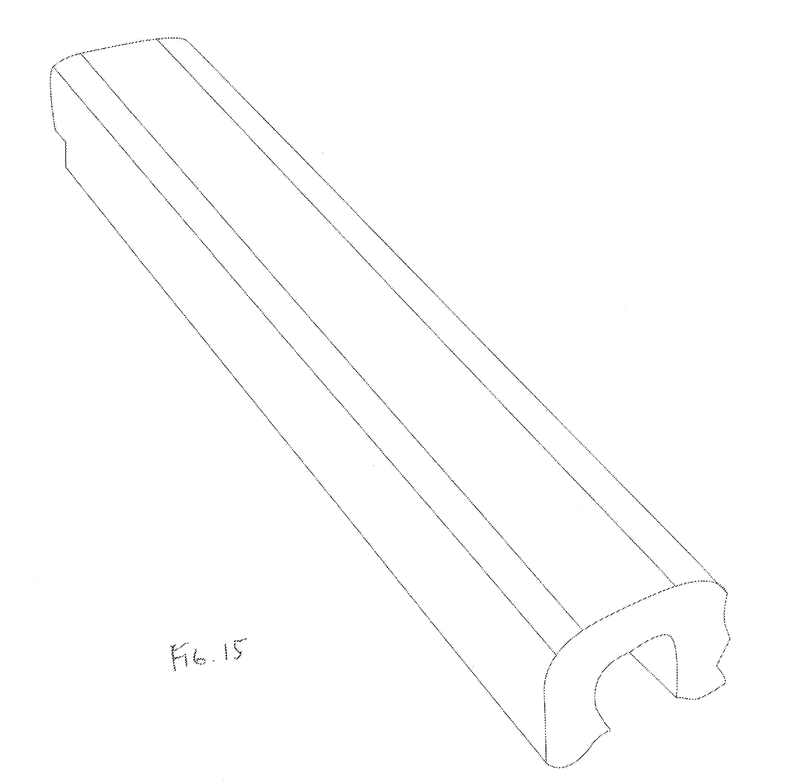

Further, whereas the illustrated clips are provided one for each corner and grip the angularly extending members thereof, the clips could equally grip only a single linear part of the frame; such a clip is shown in FIG. 15. Of course, the clips could have various shapes and need not be resiliently-deformed snap-type clips; for example, spring clips (such as clothespins) could be utilized, as could clips that use turnscrews (such as C-clamps).

Accordingly, the invention should be understood to be limited only by the accompanying claims, purposively construed.

1. Apparatus for use with a refuse container and a refuse bag, the container being of the type having a mouth which presents vertically upwardly in use and a rim which defines the entry to the mouth, the bag being of the type having an end portion which defines a mouth of the bag;
the apparatus comprising:
a bag holder which, in use, is disposed at an operative position relative to the container and suspends the bag interiorly of the container such that the mouth of the bag is open, presents upwardly and is disposed adjacent the rim of the container; and
securement apparatus which, in use, holds the bag holder at the operative position.

2. Apparatus according to claim 1, wherein the bag holder includes:
a frame about which the end portion is draped in use; and
a clip adapted to grip around the frame and, in use, the bag.

3. Apparatus according to claim 2, wherein the bag holder comprises a plurality of clips.

4. Apparatus according to claim 3, wherein:
the frame has a plurality of portions, each portion including a pair of elongate members disposed in angular relation; and
a clip is provided for each of said plurality of portions, the clip being adapted to grip a substantial portion of the length of each of the members of said each portion.

5. Apparatus according to claim 4, wherein, in each portion, the elongate members of the pair are disposed in perpendicular relation to one another.

6. Apparatus according to claim 2, wherein
the securement apparatus is defined by a plurality of grips, each grip having a fixed end connected to the frame and a free end which, in use, is releasably coupled to the refuse container.

7. Apparatus according to claim 6, wherein the free end is a hooked end which, in use, receives the rim in gripping relation.

8. Apparatus according to claim 6, wherein:
the frame has a plurality of linear sections; and
the fixed ends of the grips are pivotally connected to the linear sections for movement around pivot axes defines by the linear sections.

9. Apparatus according to claim 8, wherein
the frame is bisected into two parts, hingedly connected to one another for relative movement about a hinge axis in the manner of the leaves of a book; and
the linear sections are orientated parallel to the hinge axis.

10. Apparatus according to claim 8, wherein the plurality of grips is a pair of grips, the grips being relatively elongate in the direction of the linear section to resist pivotal movement of the bag holder in the container.

11. Apparatus according to claim 9, wherein, when the parts are disposed in coplanar relation, the frame is substantially rectangular.

12. Apparatus according to claim 1, wherein, in use, the mouth of the bag is disposed beneath the rim of the container.

13. Apparatus for use with a refuse container, a refuse bag and a plurality of clips,
the container being of the type having a mouth which presents vertically upwardly in use and a rim which defines the entry to the mouth,
the bag being of the type having an end portion which defines a mouth of the bag;
the apparatus comprising:
a frame which, in use, is disposed at an operative position relative to the container and is engaged by the clips to suspend the bag interiorly of the container such that the mouth of the bag is open, presents upwardly and is disposed adjacent the rim of the container; and
securement apparatus which, in use, holds the frame at the operative position.
